(19) United States
(12) Patent Application Publication
(10) Pub. No.: US 2008/0080948 A1
(43) Pub. Date: Apr. 3, 2008

(54) RAIL TO TRUCK PANEL ATTACHMENT MOUNT

(75) Inventors: Paul E. BARCLAY DE TOLLY, Portsmouth, RI (US); Thomas E. Derecktor, Portsmouth, RI (US); Steve J. Winckler, Troy, NY (US)

Correspondence Address: PILLSBURY WINTHROP SHAW PITTMAN, LLP, P.O. BOX 10500, MCLEAN, VA, 22102, US

(73) Assignee: TRACRAC, INC., Fall River, MA (US)

(21) Appl. No.: 11/531,321

(22) Filed: Sep. 13, 2006

(51) Int. Cl. F16B 21/00

(52) U.S. Cl. 411/340

(57) ABSTRACT

An attachment mount is provided to securely attach an accessory to a panel, such as a vehicle panel. The mount includes a base that may receive a rail and a toggle guide. A bolt is provided and passes through the rail, the base, and the toggle guide for attachment of a toggle at its end. The toggle may pivot or move into a insertion configuration and be pushed through an opening in a panel to which attachment is desired. Once the toggle has passed through the panel opening, a biasing element, such as a spring, may urge the toggle to move to an engaging configuration. As the bolt is rotated, the toggle may then be guided by the toggle guide and be drawn into proximity of the base and to engage the panel. Complementary structure on the base and the toggle act to deform the panel, thereby creating a strong attachment.

### FIELD OF THE INVENTION

The present invention relates to attachment devices and, more particularly, to an attachment mount that attaches a rail to a vehicle panel for supporting substantial loads.

### BACKGROUND OF THE INVENTION

Various attachment mechanisms are used to attach accessories, tools, toolboxes, frames, caps, or other structures to vehicles, such as pickup trucks. Such structures are typically attached to the top or inside surface of the side panels of the truck bed or to the top or inside surface of the tailgate. There is a constant desire in the art to make improvements to such attachment mounts so that strength is maximized and so that such mounts are capable of supporting greater weight in various directions of load application (e.g., out-of-plane loads).

### SUMMARY OF THE INVENTION

In accordance with an embodiment of the present invention, a method for attaching an object to a panel is provided. A toggle provided on the object is inserted into an opening in the panel so that the panel is positioned between the object and the toggle. The toggle is in an insertion configuration as it passes through the opening and moves to an engaging configuration after passing through the hole. The toggle is then moved towards the object and the panel so as to engage the toggle with the panel and deform the panel between the object and the toggle.

According to a further embodiment of the present invention, an attachment mechanism is provided that includes a base provided on an object being attached and a toggle. A toggle guide is provided on the base, the base and the toggle being configured to be drawn together by movement of the toggle along the toggle guide so that a panel is engaged between the base and the toggle. The base and the toggle each have engagement surfaces for engaging the panel. The engagement surfaces are configured complementarily to one another for deforming the panel into conformance with the engagement surfaces.

Other objects, features, and advantages of the present invention will become apparent from the following detailed description, the accompanying drawings, and the appended claims.

### BRIEF DESCRIPTION OF THE DRAWINGS

The above-mentioned and other features and advantages of this disclosure, and the manner of attaining them, will become more apparent and the disclosure itself will be better understood by reference to the following description taken in conjunction with the accompanying drawings, wherein:

FIG. 1 is a perspective view illustrating a rail installed on a pickup truck bed in accordance with the present invention, with close-up views isolating one area of attachment;

FIG. 2 is a perspective view of an attachment mount from the inner bed side of a panel in accordance with the present invention;

FIG. 2A is a perspective detail view of a toggle nut in accordance with the present invention;

FIG. 2B is a front view of a coil spring for biasing a toggle in accordance with the present invention;

FIG. 3 is a perspective view of an attachment mount from the back or outboard side of a panel in accordance with the present invention;

FIGS. 4-9 show the steps in the process of securing a rail to a vehicle panel via an attachment mount in accordance with the present invention; and

FIG. 10 shows the attachment mount, rail, and panel in the final, attached, configuration in accordance with the present invention.

The invention will be described with reference to the accompanying drawings. Corresponding reference characters indicate corresponding parts throughout the several views. The description as set out herein illustrates an arrangement of an embodiment of the present invention and is not to be construed as limiting the scope of the disclosure in any manner.

### DETAILED DESCRIPTION OF THE ILLUSTRATED EMBODIMENT

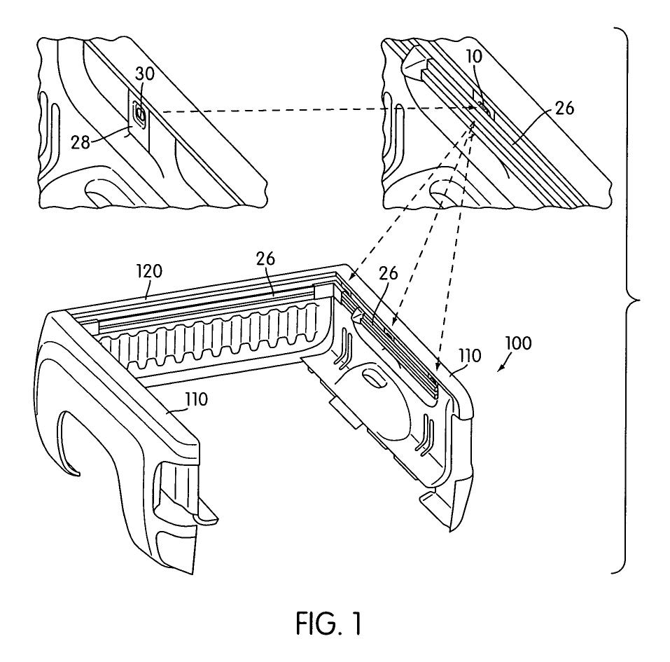

FIG. 1 shows the application of the present invention to a conventional pickup truck bed 100, although the invention may be applied in other contexts. The invention comprises a rail mount 10 that is configured to engage an opening 30 in a truck bed side I TO, tailgate 120, or cab panel (not shown) so that it may support a rail 26. The rail 26 may be used, for example, for securely attaching accessories to the truck bed, such as tools, toolboxes, bicycle mounts, a tonneau cover or any other conventional truck mounted apparatus. For example, the rail 26 may be mounted on one parallel side wall of a truck bed, and an identical rail may be mounted to the opposite side wall. These parallel rails could be used to slidably mount a toolbox for fore and aft movement within the truck bed. Due to various space restraints, for example due to stake pocket enclosures, there is little space behind truck bed panels for mounting hardware. The present invention addresses these and other limitations by providing a toggle mount configured to be mounted in such spaces.

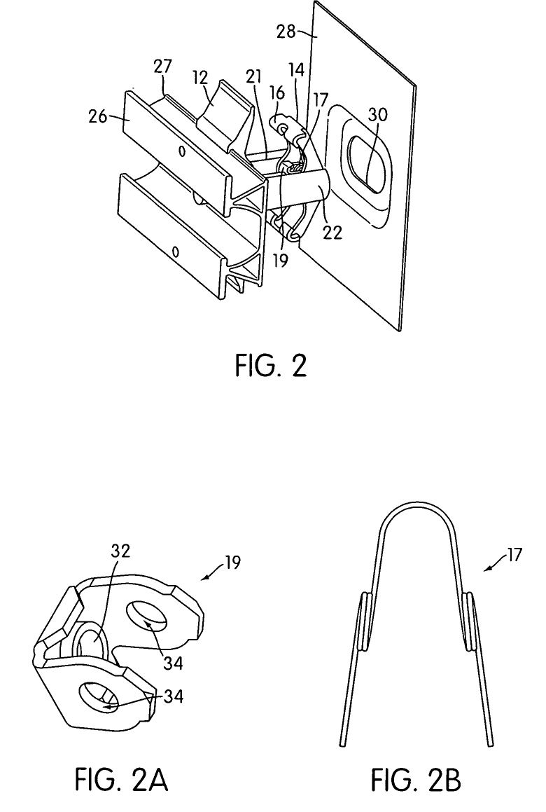

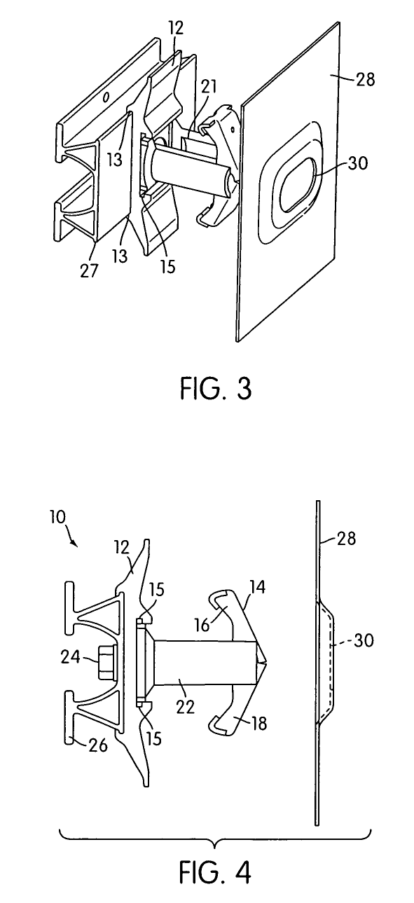

As shown in FIGS. 2 and 3, the mount 10 includes a saddle 12, toggle 14, toggle guide 22, and bolt 24. Prior to attachment to the truck bed side panel 28, the saddle 12 may be crimped or otherwise attached to an attachment side of the rail 26. Alternatively, the saddle 12 may slide onto the rail 26. The saddle 12 may have opposing grooves 13 for this purpose that slide over opposing edges or flanges 27 located on the attachment side of the rail 26. The grooves 13 and edges 27 may be designed to support substantial loads.

Although the illustrated embodiment illustrates a saddle 12 that mounts to the rail 26, a separate saddle 12 need not be used. Instead, the rail 26 itself could have its base configured for engagement with the panel 28. Thus the term “base” may be used broadly to refer to the base portion of the rail 26, or the saddle 12 which mounts on the base portion of the rail 26. The following description will continue to refer to the saddle 12 as illustrated, but this should not be taken as limiting.

Next, the toggle guide 22 may be slid into grooves 15 of the saddle 12 or otherwise attached. The toggle guide 22 has two leg portions each having opposing inwardly facing channels 21 running along the inside length. Both the saddle 12 and the toggle guide 22 have through-holes to permit the passage of a bolt 24. The bolt 24 also passes through a collinear or coaxial hole in the rail 26, which may be pre-existing or drilled during installation.

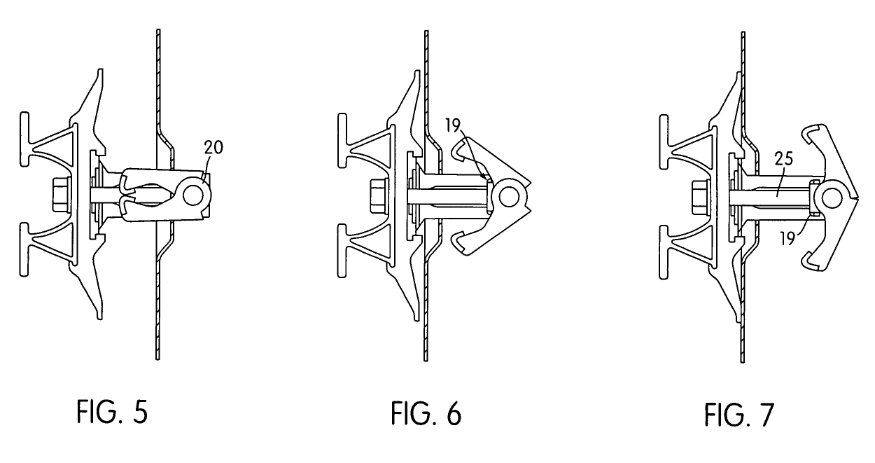

A toggle 14 is then inserted into the toggle guide 22 and threaded onto an end of the bolt 24. The bolt 24 is received by a threaded toggle nut 19, shown in detail in FIG. 2A, having threads 32. The toggle 14 has an upper portion 16 and a lower portion 18 that are pivotally joined by rivets 20 at their sides (see FIGS. 5-7). Rivets 20 may also secure the toggle nut 19 to the toggle 14 at the junction of the portions 16, 18, via holes 34 in the nut 19 and toggle 14. The rivets 20 have cylindrical heads that may be held in place and guided by the channels 21 of the toggle guide 22. A coil spring 17, such as that shown in FIG. 2B, may be provided at the juncture of the upper portion 16 and the lower portion 18 of the toggle 14 in order to bias the portions 16, 1 8 to the relative positions shown in FIGS. 2-4. Suitable abutting structure at the meeting surfaces of the upper 16 and lower 18 portions provides the counterforce to the spring 17, maintaining the toggle 14 in the expanded position shown in, for example, FIGS. 2-4.

The steps in the attachment process are shown in FIGS. 4-10. As shown in FIG. 4, the rail 26 having the mount 10 secured thereto is brought into proximity of the truck bed side panel 28, which may have a recessed or indented portion with opening 30 that may be offset from or out of plane with the general plane of the panel 26, as shown, for increased strength characteristics. As the toggle 14 is pushed against the panel 28 and through the opening 30, the upper portion 16 and lower portion 18 are urged against the force of the spring 17 into the closed or compacted position shown in FIG. 5. Each of the free ends of the upper portion 16 and the lower portion 18 are notched to avoid interference with the bolt 24 and allow the toggle portions 16, 18 to move closer to one another (see FIG. 2). In the closed or compacted position, the toggle 14 may pass through the opening 30. One of skill in the art will appreciate that the present invention may be applied to panels that are not provided with a recess or indented portion, i.e., flat panels having a piercing.

As shown in FIGS. 6 and 7, once the toggle 14 passes through the opening 30, the spring 17 resiliently returns the upper 16 and lower 18 portions to the open, expanded, and obstructive configuration. The rail 26 and saddle 12 may then be further urged against the panel 28 until the upper and lower portions of the saddle 12 abut the panel 28, as shown in FIG. 7.

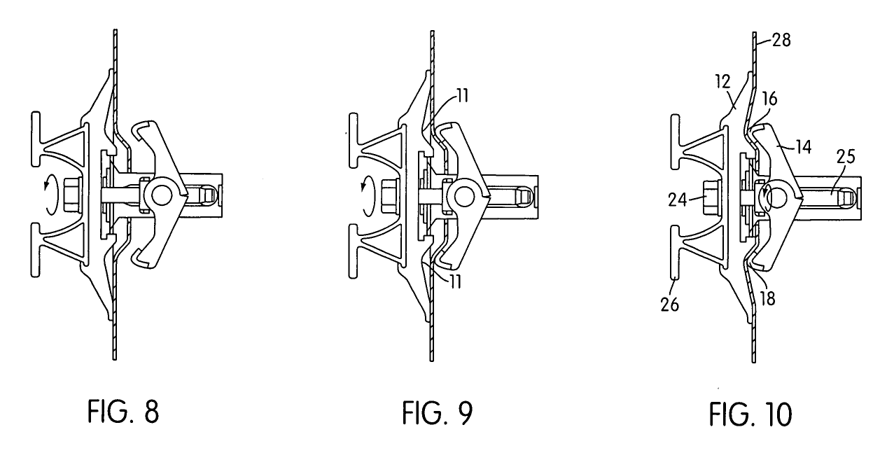

As shown in FIGS. 8 and 9, a torque is applied to the bolt 24 to draw the toggle 14 closer to the rear side of the panel 28. As discussed above, the toggle rivets 20 are guided by channels 21 in the toggle guide 22 so as to prevent rotation of the toggle 14 due to the rotation of the bolt 24. Simultaneously, the threaded engagement between the nut 19 and the bolt 24 will cause the toggle 14 to travel axially along the bolt 24 towards the panel 28. Each of the upper 16 and lower 18 portions of the toggle are drawn, by rotation of the bolt 24, to come into contact with the side of the panel 28 that is opposite to the saddle 12, as shown in FIG. 9.

Upon further rotation of the bolt 24, the panel 28 is deformed by the saddle 12 and toggle 14, as shown in FIG. 10, to provide a high strength attachment. Because the panel 28 is typically a high strength metal, the deformation may be a plastic deformation, particularly at the points where bending occurs. As shown, the ends of each of the portions 16, 18 of the toggle coincide with, on opposite sides of the panel 28, depressions 11 in the saddle 12 to allow room for deformation, or “tenting” of the panel 28. The panel engaging portions of the upper 16 and lower 18 portions of the toggle 14 therefore form complementary engagement surfaces with the panel engaging portions of the saddle (or base) 12 and deform the panel 28 between each of the complementary engagement surfaces. Specifically, the panel engaging portions on the upper and lower portions 16, 18 push the panel inwardly against those depressions so that the panel in that region takes a shape conforming to the depressions and/or the panel engaging portions. By deforming the panel 28, it is thereby pre-tensioned and is capable of supporting significant loads placed on the rail 26.

In an alternative embodiment (not shown), the toggle may comprise a single or unitary element that is received by the bolt 24 and may include guide following members or rivets configured to slide within the toggle guide channels 21. A single element or unitary toggle may be permitted to rotate about a pivot point about, or in the vicinity of, its guide followers so that it may be positioned in a compact insertion configuration in which it is oriented generally parallel to the toggle guide legs. The toggle may then be passed through a panel piercing 30 and then moved to an obstructive or engaging configuration in which it may not be pulled back out of the piercing. For example, the toggle may be pushed either manually or by a biasing element (e.g., a spring) to rotate from a compact orientation parallel with the toggle guide legs to an obstructive orientation perpendicular to the toggle guide legs. The remainder of the attachment process may proceed as discussed above with respect to a multiple portion expandable toggle 14. In this embodiment, the single element or unitary toggle may have a shape that resembles the multiple portion expandable toggle 14 when in the expanded configuration, as shown in FIG. 4.

Likewise, in the insertion configuration the toggle could align with and pass through the panel opening, and in the engaging configuration it could be rotated (e.g., 90 degrees) so that it cannot be withdrawn through the opening and engages the panel in the areas adjacent the opening.

While specific embodiments have been described above, it will be appreciated that the subject of the present disclosure may be practiced otherwise than as described. The descriptions above are intended to be illustrative, not limiting. Thus, it will be apparent to one skilled in the art that modifications may be made without departing from the scope of the claims set out below.

What is claimed is:

1. A method for attaching an object to a panel, comprising:
inserting a toggle provided on the object into an opening in the panel so that the panel is positioned between the object and the toggle, the toggle being in an insertion configuration as it passes through the opening and moving to an engaging configuration after passing through the hole,
moving the toggle in the engaging configuration towards the object and the panel so as to engage the toggle with the panel and deform the panel between the object and the toggle.

2. A method according to claim 1 wherein the object has a panel engaging portion with engagement surfaces that engage the panel, and wherein the engagement surfaces on the panel engaging portion are configured complementarily to engagement surfaces on the toggle that engage an opposite side of the panel, the panel being deformed between the complementary engagement surfaces.

3. A method according to claim 1, further comprising guiding the movement of the toggle with a toggle guide attached to the object.

4. A method according to claim 3, wherein the toggle guide has two legs extending away from the object, the legs having channels for guiding the toggle.

5. A method according to claim 1, wherein the toggle is moved towards the object by rotation of a bolt passing through the object and engaging with a threaded toggle nut secured to the toggle.

6. A method according to claim 1, wherein the opening in the panel is out of plane with the general panel plane.

7. A method according to claim 1, wherein the object is a rail and the panel is a panel located on a vehicle, the rail being configured to mount accessories.

8. A method according to claim 1, wherein the toggle comprises an upper portion and a lower portion, the upper portion and the lower portion having ends that are in close proximity to each other in the insertion configuration and move further away from each other in the engaging configuration.

9. An attachment mechanism comprising:
a base provided on an object being attached;
a toggle; and
a toggle guide provided on the base,
wherein the base and the toggle are configured to be drawn together by movement of the toggle along the toggle guide so that a panel is engaged between the base and the toggle, the base and the toggle each having engagement surfaces for engaging the panel and the engagement surfaces being configured complementarily to one another for deforming the panel into conformance with the engagement surfaces.

10. The attachment mechanism of claim 9, wherein the base is configured to carry a rail.

11. The attachment mechanism of claim 9, further comprising a bolt in threaded engagement with the toggle such that a rotation of the bolt acts to draw the toggle toward the base.

12. The attachment mechanism according to claim 9, wherein the toggle has shaped rivet heads that are guided by channels in the toggle guide.

13. The attachment mechanism according to claim 9, wherein the toggle guide comprises two leg portions extending in a direction away from the base, the leg portions having channels to guide the toggle to move in a space between the leg portions.

14. The attachment mechanism according to claim 9, wherein the toggle comprises an upper portion and a lower portion, the upper portion and the lower portion configured to pivot between an insertion configuration and an engaging configuration.
